(19) United States
(12) Patent Application Publication
(10) Pub. No.: US 2023/0371542 A1
(43) Pub. Date: Nov. 23, 2023

(54) CAPSULE FOR PREPARING A BEVERAGE AND METHOD FOR THE PRODUCTION AND USE THEREOF

(71) Applicant: DELICA AG, Buchs AG (CH)

(72) Inventors: Caroline SIEFARTH, Basel (CH); Christina Sophie NOEVER, Basel (CH); Kathrin STEINBRÜCKNER, Birsfelden (CH); Tim THILLA, Weil am Rhein (DE); Roland AFFOLTER, Möriken (CH)

(73) Assignee: Delica AG, Buchs AG (CH)

(21) Appl. No.: 18/248,702

(22) PCT Filed: Oct. 8, 2020
(86) PCT No.: PCT/EP2021/077844

§ 371 Date: Apr. 12, 2023

(30) Foreign Application Priority Data
Oct. 14, 2020 (EP) 20201868.5

(51) Int. Cl. A23F 5/12; A23P 10/25; A23P 20/10; A23F 5/14; A47J 31/40

(52) U.S. Cl. CPC A23F 5/125; A23P 10/25; A23P 20/10; A23F 5/14; A47J 31/407

(57) ABSTRACT

A capsule for preparing a beverage, in particular a hot beverage, consisting of a compact of a material selected from the group consisting of instant coffee, instant tea, soluble coffee substitute extract, cocoa, drinking chocolate, milk powder, vegan milk substitute powder, dry soup, protein powder, fillers, food supplements, and combinations thereof, wherein the capsule is configured such that it dissolves in, in particular, hot water.

The present invention relates to a capsule for the preparation of a beverage, in particular a hot beverage, which has suitable ingredients and dissolves in, in particular, hot water, as well as a method for the preparation thereof, the use thereof in a beverage preparation machine and a system comprising a beverage preparation machine and a capsule according to the independent patent claims.

The provision of a luxury food such as coffee in capsule form is well known. However, the materials usually used for the capsules, such as plastics or aluminum (see e.g. EP-2 106 375 A2), have the disadvantage that they are not compostable. Such capsules must be disposed of or collected separately and recycled.

In DE 10 2014 0001 87 B4, it was proposed to coat a compact for the production of, for example, coffee with a coating material consisting of a biodegradable layer, this layer being a polysaccharide or a derivative thereof in combination with a polyol spacer and an associated crosslinker, i.e. a crosslinked polysaccharide. A specific embodiment is not described.

EP-3 115 316 B1 describes a similar capsule for the production of, for example, coffee, in which the crosslinked polysaccharide in the coating material was obtained without the use of a polyol spacer. Specifically, calcium alginate is mentioned as the coating material.

In US-2013/0136843 A1, it is proposed to coat a core of coffee powder with a shell of compacted coffee.

However, the aforementioned prior art solutions are not optimal with respect to providing a capsule for preparing a hot beverage under the most economical, ecologically compatible and manufacturing aspects possible.

It is an object of the present invention to provide a capsule for preparing a beverage, in particular a hot beverage, which overcomes the disadvantages of the prior art.

The task is solved by the subject matter of the independent claims of the present application.

The present invention relates to a capsule for preparing a beverage in a beverage preparation machine, in particular a hot beverage, comprising a compact and optionally a shell. The compact thereby consists of a material selected from the group consisting of instant coffee, instant tea, soluble coffee substitute extract such as, for example, spelt coffee, barley coffee or lupine coffee, cocoa, drinking chocolate, milk powder, vegan milk substitute powder, dry soup, protein powder, fillers, food supplements and combinations thereof. The capsule is water soluble. Accordingly, the capsule does not contain ground roasted coffee and tea leaves.

A capsule that dissolves in water is an optimal solution for the consumer. No waste material is produced during the preparation of the beverage, which must be disposed of or collected separately and recycled.

According to the present invention, a “compact” is understood to be a material that has been compressed under pressure. The provision of the material of the capsule as a compact is advan-tageous in order to simplify handling for the user. In particular, dosing and feeding into a beverage preparation machine are simplified. For this purpose, the material preferably has a cer-tain strength. This can be achieved by compressing the material, for example, with a compression pressure in the range of 1-100 MPa, preferably 5-50 MPa.

According to the present invention, a capsule is considered dissolved in water when at least 90% of the capsule has gone into solution or is dispersed in it. In this case, the material of the capsule dissolves in a brewing chamber during a brewing process of up to 3 min duration and a water pressure adapted to the beverage to be prepared or to the pressed product. Depending on the material of the compact, the capsule can be intended for the preparation of a hot or cold beverage. For hot beverages, the material of the capsule dissolves at 60° C. and above. For cold drinks, temperatures up to a maximum of 30° C. are envisaged, at which the capsule should dissolve in water. In addition, a shorter brewing process with lower water pressure may be set for easily soluble pressed beverages, and a longer brewing process with higher water pressure may be required for poorly soluble pressed beverages. A water pressure can be easily realized with a back pressure valve on the outlet side of a brewing chamber of a beverage preparation machine.

A backpressure valve allows air to be introduced into the beverage. The introduction of air results in foam on the surface of the beverage. The introduction of air also improves the mouth-feel of the beverage. It appears fuller-bodied and creamier to the user.

The shell of the capsule, if one is used, should also be made of a water-soluble material. For example, a coating of sodium alginate can be applied to the compact. For this purpose, a system is provided in the form of a solution, in particular an aqueous solution, with a concentration of sodium alginate between 1% and 5% w/w, preferably between 1.2% and 2.5% w/w, particularly preferably between 1.5% and 2% w/w, based on the total weight of the system. In this context, a system is not understood to mean only an aqueous system (i.e. a system comprising exclusively water as solvent). It is equally conceivable that the system is a solvent mixture of water and a water-miscible solution, for example of low-chain (e.g., C₁₋₈), physiologically acceptable alcohol, such as ethanol. Similarly, it is conceivable that a coffee extract, for example from a brewed coffee or from an instant coffee, is used instead of water as a solvent to create the aqueous system. The coating of the compact with the coating material can be achieved, for example, by immersing the compact in the system described above. The compact may be introduced into the system via a suitable suspension, where it remains for a desired time, for example for 1 to 60 s, preferably 2 to 30 s, more preferably 3 to 10 s. Other methods of coating in an immersion bath, for example with a fixed position in the immersion bath or rolling locomotion through the immersion bath, are conceivable. Subse-quently, the compact surrounded (i.e. coated) on its surface with envelope material is removed from the system and dried. The coating can consist of several layers applied in this way.

The capsule may have a volume ratio of between 1:1 to 1:5, preferably between 1:1.2 to 1:3, more preferably 1:1.4 to 1:1.6, to the volume of the brewing chamber.

The compact can have a breaking strength of at least 10 N, in particular more than 15 N, preferably more than 20 N, particularly preferably more than 25 N, or even more than 30 N. This breaking strength is relevant for the handling of the capsule. For example, it should not break or disintegrate during transport or use by the user, in particular when placed in a corresponding beverage preparation machine.

The breaking strength of the compact is determined by subjecting the compact to a force test in a material testing machine. For this purpose, the test specimens are subjected to a continuously increasing force between two parallel compression plates. The load is increased until the test specimen cracks or breaks, accompanied by a drop in force. The maximum force is output as the compressive or ultimate strength. This method is also described in WO 2008/123775 A1, p.3. For example, the braking strength of the compact is tested using a tensile-compression testing machine with an Xforce P load cell from Zwick/Roell.

On the one hand, the required breaking strength can be achieved by applying an appropriately selected compression pressure during the manufacture of the compact. On the other hand, however, the composition of the material of the compact is also essential for its breaking strength. Here, in particular, the following compositions have proven to be suitable:
0-40 wt % instant coffee,
60-100 wt % powdered milk or vegan milk substitute powder.

According to the present invention, the material is selected from the group consisting of instant coffee, instant tea, soluble coffee substitute extract such as spelt coffee, barley coffee or lupine coffee, cocoa, drinking chocolate, milk powder, vegan milk substitute powder, dry soup, protein powder, fillers, food supplements and combinations thereof. Such materials are well known and need not be discussed in detail here. What is essential is that these materials dissolve in water.

The capsule according to the invention can have various shapes. A variety of such shapes is already known in the prior art for corresponding capsules in the relevant technical field. For example, the capsule may have a shape selected from the group consisting of sphere, ellipsoid, cube, cuboid, cylinder, prism, cone, truncated cone, pyramid, truncated pyramid, torus, tetrahedron, octahedron, dodecahedron, icosahedron and coffee bean. Preferably, the capsule is spherical.

The capsule preferably has a weight between 4 g and 15 g, preferably between 5 g and 13 g, particularly preferably between 6 g and 11 g. It has been shown that this amount of material can be used to produce one portion of a flavorful beverage.

The capsule can have a largest diameter between 10 mm and 50 mm, preferably between 15 mm and 40 mm, particularly preferably between 20 mm and 35 mm. This size of capsule has proven to be user-friendly. In addition, this is a size which can be easily supplied in multiple packs in the retail trade.

The compact can contain more than 50% by weight of binder. It has been shown that, in particular, instant coffee requires a relatively high proportion of binder in order to be able to produce a stable compact. A binder is understood to be a second material component which helps a first material component to form a stable compact in accordance with the requirements.

The function of the binder can be assumed by the milk powder, for example. Accordingly, the milk powder is the binder. No ad-ditional separate binder is required.

The milk powder can be selected from the group of skimmed milk powder, whole milk powder, coconut milk powder, oat milk powder, almond milk powder or a combination thereof. It goes without saying that other, in particular vegan, milk substitute powders can also be used, such as soy milk powder, rice milk powder, spelt milk powder, millet milk powder, hemp milk powder, lupine milk powder, pea milk powder, quinoa milk powder, cashew milk powder or hazelnut milk powder.

The compact can consist of 60 wt % coconut milk powder and 40 wt % instant coffee. However, other compositions and mixing ratios are also possible, as the following table shows as an example for spherical pressing at 30 MPa:

| | | | | Break |
|---|---|---|---|---|
| Comp. 1 | Comp. 2 | % Comp 1 | % Comp 2 | resistant. (N) |
| Whole milk | Without | 100 | 0 | 18 |
| powder | | | | |
| Skim milk | without | 100 | 0 | 124 |
| powder | | | | |
| Skim milk | Instant coffee | 80 | 20 | 11 |
| powder | | | | |
| Cocoa milk | Without | 100 | 0 | 54 |
| powder | | | | |
| Coconut milk | without | 100 | 0 | 25 |
| powder | | | | |
| Coconut milk | Instant coffee | 80 | 20 | 30 |
| powder | | | | |
| Coconut milk | Instant coffee | 70 | 30 | 16 |
| powder | | | | |
| Coconut milk | Instant coffee | 60 | 40 | 17 |
| powder | | | | |
| Almond milk | without | 100 | 0 | 20 |
| powder | | | | |
| Almond milk | Instant coffee | 80 | 20 | 12 |
| powder | | | | |
| Almond milk | Instant coffee | 75 | 25 | 10 |
| powder | | | | |
| Almond milk | Instant coffee | 70 | 30 | 10 |
| powder | | | | |

The compact can be homogeneous throughout. In this context, homogeneous means that the compact is uniformly compressed over its cross-section and has the same density over the cross-section. In addition, the materials of the compact are uniformly mixed throughout.

The capsule according to the invention can be manufactured by producing a compact of the desired material or material composition.

The present invention also relates to a method of manufacturing a capsule, in particular as described above, comprising the steps of
a) Providing a material selected from the group consisting of instant coffee, instant tea, soluble coffee substitute extract such as spelt coffee, barley coffee, or lupine coffee, cocoa, drinking chocolate, milk powder, vegan milk substitute powder, dry soup, protein powder, bulking agents, nutritional supplements, and combinations thereof,
b) Compacting the material into a compact, wherein the material of the capsule is water soluble, especially in hot water.

Compacting the material into the form of a compact is known and has been described above.

The capsule according to the invention can be used to prepare a beverage, in particular a hot beverage, selected from the group comprising coffee, tea, coffee substitute, cocoa, drinking chocolate, milk or soup, or combinations thereof. In this process, the capsule dissolves, as explained above.

According to the invention, it is preferred that the beverage is prepared by dissolving the capsule with an especially hot liquid selected from the group consisting of water and milk. This dissolves the capsule.

Corresponding preparation processes and devices for this purpose are known from the prior art.

The present invention also relates to the use of a capsule as described above in a beverage preparation machine. In this case, the beverage preparation machine has a brewing chamber for receiving and enclosing the capsule. Under the influence of, in particular, hot water or, in particular, hot milk, the capsule dissolves in the brewing chamber of the beverage preparation machine.

By dissolving the capsule in a brewing chamber of the beverage preparation machine, no residual material is produced; accordingly, no residual material container needs to be emptied regu-larly.

The present invention further relates to a beverage preparation machine and a capsule as described above. Again, the beverage preparation machine herein comprises a brewing chamber for receiving, enclosing and, in particular, dissolving the capsule.

The dissolution of the capsule in the brewing chamber can take place under the influence of, in particular, hot water or, in particular, hot milk.

In the examples listed below, 20 compacts were produced in each case. For the sake of simplicity, only the singular will be used in the following. The breaking strength of half of the compacts was measured. The other half of the compacts was exposed to water at up to 93° C. in the brewing chamber of a beverage preparation machine for a preparation time of up to 3 min. The compacts dissolved completely.

### EXAMPLE 1

A spherical compact for the preparation of a vegan latte was prepared by compacting 8 g of a mixture of 40 wt % instant coffee and 60 wt % coconut milk powder in a press at 30 MPa. The compact exhibited a mean breaking strength of 17 N.

### EXAMPLE 2

A spherical compact for the preparation of a latte was prepared by compacting 7.5 g of a mixture of 20 wt % instant coffee and 80 wt % skim milk powder in a press at 30 MPa. The compact had an average breaking strength of 11 N.

### EXAMPLE 3

A spherical compact for the preparation of a cocoa milk was prepared by compacting 10.2 g of a mixture of sugar, sweet whey powder, low-fat cocoa powder, skim milk powder and salt in a press at 30 MPa. The compact exhibited a mean breaking strength of 54 N.

### EXAMPLE 4

A spherical compact for the preparation of a milk drink was produced by compacting 7.5 g of skim milk powder in a press at 30 MPa. The compact had a mean breaking strength of 124 N. The beverage was prepared using water at a temperature of 25° C. A cold drink was prepared. The compact dissolved completely.

1. A capsule for preparing a beverage in a beverage preparation machine comprising a compact wherein the compact consists of a material selected from the group consisting of instant coffee, instant tea, soluble coffee substitute extract, cocoa, drinking chocolate, milk powder, vegan milk substitute powder, dry soup, protein powder, fillers, food supplements and combinations thereof, wherein the capsule is configured such that it dissolves in in particular hot water.

2. The capsule according to claim 1, wherein the compact has a breaking strength of at least 10 N.

3. The capsule of claim 1, wherein the compact has a shape selected from the group consisting of sphere, ellipsoid, cube, cuboid, cylinder, prism, cone, truncated cone, pyramid, truncated pyramid, torus, tetrahedron, octahedron, dodecahedron, icosahedron, and coffee bean.

4. The capsule according to claim 1, wherein the capsule has a weight between 4 g and 15 g.

5. The capsule according to claim 1, wherein the capsule has a largest diameter between 10 mm and 50 mm.

6. The capsule according to claim 1, wherein the compact comprises more than 50% by weight binder.

7. The capsule of claim 6, wherein the milk powder is the binder.

8. The capsule of claim 1, wherein the milk powder is selected from the group consisting of skim milk powder, whole milk powder, vegan milk substitute powders, or a combination thereof.

9. The capsule of claim 1, wherein the compact consists of 80% by weight milk powder and 20% by weight instant coffee.

10. The capsule according to claim 1, wherein the compact is homogeneously formed throughout.

11. A method for preparing a capsule for the preparation of a beverage, comprising the steps of
a) providing a material selected from the group consisting of instant coffee, instant tea, soluble coffee substitute extract, cocoa, drinking chocolate, milk powder, vegan milk substitute powder, dry soup, protein powder, bulking agents, nutritional supplements, and combinations thereof,
b) compacting the material into a compact,
wherein the material is water-soluble.

12. The method of claim 11, wherein compacting the material is performed at a compression pressure in the range of 1-100 MPa.

13. The method of claim 11, wherein the compact is provided with a water-soluble shell.

14-16. (canceled)

17. A beverage preparation system comprising a beverage preparation machine and a capsule according to claim 1, wherein the beverage preparation machine comprises a brewing chamber for receiving, enclosing and dissolving the capsule.

18. The beverage preparation system according to claim 17, wherein the dissolution of the capsule in the brewing chamber takes place under the influence of hot water or hot milk.

19. The capsule for preparing a beverage as in claim 1 further comprising a shell.

20. The capsule according to claim 2 wherein the compact has a breaking strength of at least 20 N.

21. The capsule according to claim 2 wherein the compact has a breaking strength of at least 30 N.

22. The capsule of claim 5 wherein the capsule has a largest diameter between 20 and 35 mm.

23. The capsule according to claim 12 wherein the compacting is performed at a compression in the range of 5-50 MPa.
